(19) United States
(12) Patent Application Publication
(10) Pub. No.: US 2016/0189948 A1
(43) Pub. Date: Jun. 30, 2016

(54) DEVICE FOR ANALYZING A SAMPLE GAS COMPRISING AN ION SOURCE

(71) Applicant: UNIVERSITÄT INNSBRUCK, Innsbruck (AT)

(72) Inventors: Martin BREITENLECHNER, Innsbruck (AT); Armin HANSEL, Innsbruck (AT)

(21) Appl. No.: 14/912,413

(22) PCT Filed: Aug. 19, 2014
(86) PCT No.: PCT/AT2014/000157

§ 371 Date: Feb. 17, 2016

(30) Foreign Application Priority Data
Aug. 19, 2013 (AT) A 647/2013

(51) Int. Cl. H01J 49/14; H01J 49/04

(52) U.S. Cl. CPC H01J 49/145; H01J 49/0422

(57) ABSTRACT

A device for analyzing a sample gas comprises an ion source for generating primary ions, a reaction chamber to which the primary ions produced in the ion source and the sample gas to be analyzed can be supplied in order to form product ions by chemical ionization of components in the sample gas, and an analyzer/detector unit for determining different types of ions. A reaction space in the reaction chamber, within which the primary ions supplied to the reaction chamber and the product ions produced are guided and which extends between a first end facing the ion source and a second end facing the analyzer/detector unit, is surrounded by at least two electrodes which are in the form of helices which wind round a common axis with identical pitches and are offset with respect to one another in the direction of the axis. An AC voltage is applied to each of the electrodes.

### BACKGROUND

1. Field of the Disclosure

The disclosure relates to a device for analyzing a sample gas comprising an ion source for generating primary ions, a reaction chamber to which the primary ions generated in the ion source and the sample gas to be analyzed can be supplied in order to form product ions by chemical ionization of components of the sample gas, and an analyzer/detector unit for determining different types of ions.

2. Discussion of the Background Art

Mass spectrometers in which ionization of a sample gas to be analyzed (=analyte gas or gaseous analyte) is performed by chemical ionization are advantageous as compared to electron impact ionization in view of a substantially reduced fragmentation. Specific kinds of such spectrometers using a chemical ionization, which are also referred to as ion molecule reaction mass spectrometers (IMR-MS), are proton transfer reaction mass spectrometers (PTR-MS). Herein, the sample gas is ionized by transferring a proton of a primary ion XH+ to a component R of the sample gas to be detected, wherein an ion RH+ is generated (and the primary ion XH+ becomes X). By means of proton transfer reaction mass spectrometers, e.g., volatile organic compounds (VOCs) can be detected in air.

Proton transfer reaction mass spectrometry and, in general, ion molecule reaction mass spectrometry are described, for example, in AT 001637 U1 and the references mentioned therein. Further descriptions of proton transfer reaction mass spectrometry can be found, i.a., in A. Hansel et al., International Journal of Mass Spectrometry and Ion Processes 149/150 (1995) 609-619 and A. Jordan et al., International Journal of Mass Spectrometry 286 (2009) 32-38.

Methods for obtaining a stream of primary ions which can be used for the chemical ionization of the sample gas can be found, for example, in EP 1 566 829 A2, AT 001637 U1, AT 406206 B and AT 403214 B.

In conventional proton transfer reaction mass spectrometers as described, e.g., in the above-mentioned reference of A. Hansel, the reaction chamber comprises a plurality of coaxial, ring-shaped electrodes arranged in a spaced-apart manner along an axis. The ring-shaped electrodes each surround a reaction space of the reaction chamber in which the primary ions react with the sample gas and product ions are generated. A DC voltage is applied to each of the electrodes, wherein there is a potential difference between neighboring electrodes. The ions in the reaction space are thus accelerated from a first end of the reaction space facing the ion source in the direction to a second end of the reaction space facing the analyzer/detector unit. By impacts of the ions with components of the sample gas, an ion-specific average drift speed and an ion-specific average impact energy are adjusted, the values of which depend on the pressure and the composition of the sample gas and the local electrical field strength. At the second end of the reaction space, the ions are supplied through an aperture to the analyzer/detector unit which determines different types of ions of the generated product ions, in particular in accordance with their mass-charge ratio.

The ion-specific average impact energy of the ions in the reaction chamber should in particular prevent the formation of clusters of these ions with components of the sample gas, e.g. H₂O in case the sample gas is moist air. If the primary ions formed clusters, e.g. H₃O⁺.H₂O clusters in case the primary ions are H₃O⁺, the sensitivity for the chemical ionization would be changed in a manner strongly dependent on the respective concretely prevailing parameters. This would prevent or strongly impair quantitative statements based on the measuring result. The interpretation of the measuring result could moreover be become much more complicated by the formation of product ion clusters. The average impact energy of the ions in the reaction chamber, however, should be so low that fragmentation of product ions is avoided at least to a large extent, because also this renders it much more complicate to interpret the measuring result.

In order to increase the sensitivity of a proton transfer reaction mass spectrometer, it has already been suggested to use a system of ion lenses (“ion funnel”) for focusing the generated product ions towards the aperture at the second end of the reaction chamber, see S. Barber et al., Analytical Chemistry, 2012, 84, 5387-5391. An ion lens for focusing ions is also described, e.g., in R. R. Julian et al., J Am Soc Mass Spectrom 2005, 16, 1708-1712. Such an ion lens device uses coaxial ring-shaped electrodes that are spaced-apart along an axis and the hole diameter of which is increasingly reduced, wherein AC voltages are applied to the electrodes which are phase-shifted by 180° between neighboring electrodes. These AC voltages generate an effective potential which focuses the ions towards the axis and thus increases the efficiency of the ion supply through an aperture into the analyzer/detector unit. DC voltages can be additionally superimposed in order to accelerate the ions towards the output of the ion lens.

A problem related with the use of such ion lenses is in particular the fact that the average impact energies of the ions vary considerably locally. The average impact energy of ions located at places with respect to the axis at which an ion lens is located is lower than the average impact energy along the entire extension of the reaction space. Thus, clusters of the primary ions are formed locally, leading to a considerably different ionization efficiency of different components. For making quantitative statements as to the proportions of the different components, involved calibrations thus would have to be made, wherein the latter strongly depend on the respective concretely prevailing parameters. The average impact energy of ions which are located with respect to the axis between two ion lenses is higher than the average impact energy along the entire length of the reaction space, which might lead to fragmentations so that it becomes difficult or impossible to interpret the result.

Also so-called “selected ion flow tubes” are known in which primary ions are supplied to a tube through which a volume flow of a sample gas is generated by pumping. In this case, the primary ions have long reaction times with the components of the sample gas to be detected, wherein, however, the cluster formations of the primary ions and also of formed product ions are so strong that the sensitivity becomes low and, moreover, it is difficult to interpret the measuring result in view of quantity.

U.S. Pat. No. 6,107,628 A discloses a means for transferring ions generated in an area in which the pressure is close to atmospheric pressure into a vacuum area. In addition to ion lenses of the kind described above, also a double helix is used for transferring and focusing the ions, said double helix being formed by two electrodes winding about one another, wherein the radius of the double helix decreases continuously towards the output of this ion transfer means. The two electrodes are supplied with AC voltages that are phase-shifted by 180°. For forcing the ions through the double helix, a DC voltage field can be superimposed, wherein a DC voltage is applied between the two ends of the electrodes being made of a material having a sufficient resistance. As a further possibility, a drive force can be generated by means of a gas flow.

U.S. Pat. No. 6,674,071 B2 also describes an ion transfer device, for example for transporting ions to be analyzed from their place of production to an analyzer/detector unit for determining different types of ions. For this purpose, a system of rod-shaped electrodes that is connected to AC voltage is used together with a surrounding electrode system that is connected to DC voltage in order to force the ions through the device. For the system of rod-shaped electrodes, several possibilities with a different number of electrodes having the shape of straight rods are shown, for example a kind of quadrupole. Furthermore, two electrodes wound about each other in the form of a double-helix are shown. The device known from this document serves mainly for transferring ions, if necessary also for temporarily storing ions. The device can additionally also be used for “cooling”, selecting or fragmenting the ions.

It is an object of the disclosure to provide an advantageous device of the kind mentioned above, said device having an increased sensitivity but nevertheless allowing quantitative measurements to be carried out easily.

### SUMMARY

The device according to the disclosure comprises at least two electrodes each having the shape of a helix, wherein the pitches of the helices winding about a common axis are identical and the helices are offset with respect to one another along the axis. Hence, the at least two electrodes wind about one another without contacting each other. These at least two electrodes surround a reaction space of the reaction chamber in which the primary ions react with the sample gas and in which the primary ions and the generated product ions are guided.

The helices are advantageously congruent, i.e. they can be caused to superpose by translation in the direction of the axis, wherein, with respect to the direction of the axis, however, the helices formed by the electrodes end at the same locations. Thus, the helices in particular have the same diameter.

The diameters of the helices formed by the at least two electrodes are preferably constant along at least more than 80%, preferably along at least more than 90% of the extension of the reaction space with respect to the direction of the axis, wherein a constant diameter of the helices along their total extension is particularly preferred.

In accordance with an advantageous embodiment of the disclosure, at least three electrodes are present, each having the shape of a helix, wherein the pitches of the helices winding about a common axis are identical and the helices are offset with respect to one another along the axis.

The offset along the axis from one helix to the next helix is preferably identical, i.e. the offset between one helix and the next helix is the pitch divided by the number of helices. In case three electrodes are used, these electrodes thus form a triple helix, wherein the electrodes are each offset by one third of the pitch of the helices with respect to one another along the axis. It is also possible to use a multiple helix formed by more than three electrodes windings about one another.

For transporting the primary ions and the generated product ions in the direction to the end of the reaction space from which they are forwarded to the analyzer/detector unit, a sample gas flow through the reaction space is advantageously generated. Thus, a volume flow of the sample gas leading in the direction to this end of the reaction space is generated. For this purpose, the sample gas can be supplied into the reaction chamber in the area of the end of the reaction chamber in which the primary ions generated in the ion source enter the reaction space, and the non-reacting sample gas can be pumped out of the reaction chamber in the area of the end of the reaction chamber in which the generated product ions exit the reaction space in the direction to the analyzer/detector unit.

When using a multiple helix formed by more than two electrodes winding about one another, transportation of the primary ions and the generated product ions in the direction to the end of the reaction space is also influenced by the presence of an effective potential which, depending on the phase positions of the supplied AC voltages, acts in the direction to the end of the reaction space from which the primary ions and generated product ions are forwarded to the analyzer/detector unit, or in the counter-direction. The transportation speed of the primary ions and the product ions is the sum of the transportation speed caused by the flow of the sample gas through the reaction space and the transportation speed caused by this effective potential. The sense of rotation of the phase determines the direction of the transportation speed caused by an effective potential. One of these two transportation speeds can be much higher than the other one so that ion transportation is caused mainly by one of these two transportation speeds. One of these two described transportation speeds can also be directed towards the end of the reaction space at which the primary ions enter the reaction space so that the overall transportation speed in the direction to the other end of the reaction space is thus reduced.

In the device according to the disclosure, acceleration of the ions in the reaction space of the reaction chamber, which serves for preventing the formation of clusters, is realized by the applied alternating field in the radial direction. This is in contrast to conventional mass spectrometers with chemical ionization in which acceleration of the ions in the reaction chamber, for preventing the formation of clusters, is in the axial direction. In the mass spectrometer according to the disclosure, the drift speed of the ions in the reaction space with respect to the axial direction is thus independent of the average impact energy of the ions for preventing the formation of clusters. Despite a sufficient average impact energy of the ions for preventing the formation of clusters, a low average drift speed in the axial direction (from the end of the reaction space facing the ion source in the direction to the end of the reaction space facing the analyzer/detector unit) can be selected. At the same time, a relatively high pressure of the sample gas in the reaction chamber can be selected, wherein the ions can nevertheless be accelerated sufficiently highly in the radial direction so that, via their free path lengths between two impacts, they can gain sufficient energy for preventing the formation of clusters. However, the lower the drift speed of the ions and the higher the pressure of the sample gas, the higher is the number of collisions between primary ions and components of the sample gas to be detected and thus the sensitivity of the device.

The average impact energy of the ions caused by the applied alternating field varies locally so little that on the one hand the formation of clusters can be prevented at least substantially and on the other hand undesired fragmentation of product ions can be avoided at least to a large extent. In particular, the average impact energy is constant with respect to the axial extension of the reaction space and shows only a relatively small change in the radial direction.

### BRIEF DESCRIPTION OF THE DRAWINGS

Further advantages of the disclosure will be discussed in the following on the basis of the attached drawings in which

FIG. 1 shows a schematic view of a device of the disclosure;

FIG. 2 shows the dependency of the average impact energy of the ions depending on its axial position in the reaction chamber in the device of the disclosure according to FIG. 1 as compared to other embodiments;

FIG. 3 shows a comparison analogously to that of FIG. 2 but relating to the dependency of the impact energy on time;

FIG. 4 shows a view of a section of the triple helix formed by the electrodes with exemplary ion trajectories.

### DETAILED DESCRIPTION OF THE PREFERRED EMBODIMENT

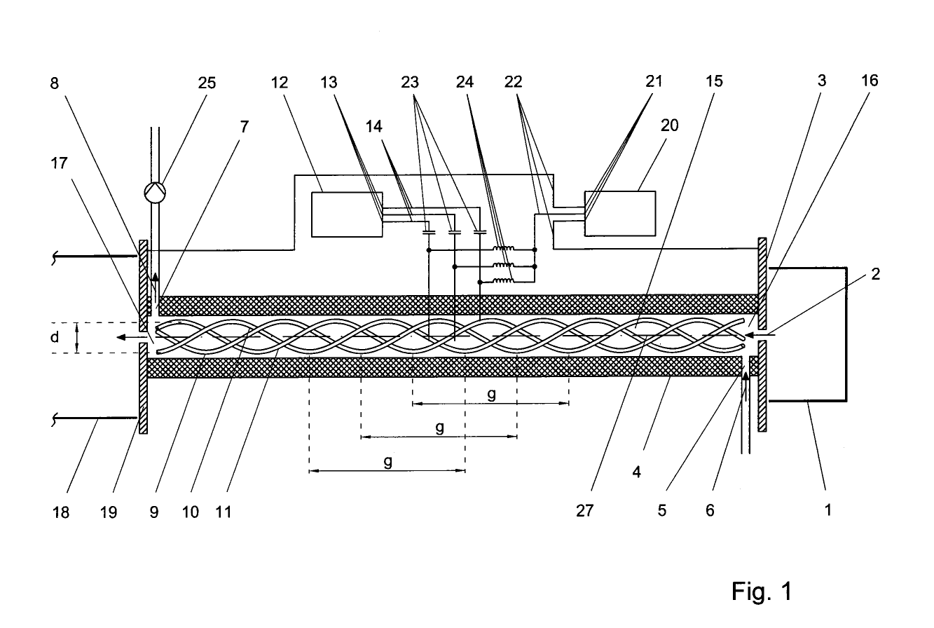

FIG. 1 shows an embodiment of a device of the disclosure in clearly schematized form. Primary ions are generated in an ion source 1. Arrow 2 indicates the primary ions exiting the ion source 1.

The primary ions exiting the ion source 1 are preferably an ion flow comprising substantially only a single type of ions. Substantially only a single type of ions means herein that the primary ions are at least 90%, preferably at least 95% ions of this species. For example, the primary ions can be substantially only H₃O⁺ ions. The primary ions can, for example, also be NH₃⁺, NO⁺, NH₄⁺ or O₂⁺ or other positively charged ions or negatively charged ions. Such ion sources 1 for generating an output ion flow comprising substantially only a single type of ions are known, for example, from the prior art cited above (e.g. according to EP 1566829 A2). It can also be possible to change the output ion flow between different types of ions. It is thus possible to carry out a chemical ionization of components of a sample gas by means of different primary ions, for example for distinguishing isomers.

Basically, it is also conceivable and possible that the primary ion flow comprises more than one type of ions, for example comprises two or three types of ions.

A gas inlet into the ion source 1 for at least one source gas for generating the primary ions is not explicitly shown in the schematic view of FIG. 1 for the sake of clarity.

The primary ions flow through an aperture 3, which limits the reaction chamber 4, into the reaction chamber 4. In accordance with the embodiment, the reaction chamber 4 directly adjoins the ion source 1. It would also be conceivable and possible to provide an intermediate chamber between the ion source 1 and the reaction chamber 4, through which intermediate chamber the primary ions generated in the ion source 1 are transferred into the reaction chamber 4. In the reaction chamber 4, components of a sample gas (=analyte gas or gaseous analyte) to be analyzed are chemically ionized. The sample gas flows through an inlet opening 5, which is located in the area of the end of the reaction chamber 4 adjacent to the ion source 1, into the reaction chamber 4. The volume flow of the sample gas through the inlet opening 5 is indicated by the arrow 6.

The non-ionized part of the sample gas, which represents by far the greatest part of the sample gas supplied through the inlet opening 5, for example more than 99 vol.-%, is pumped out through the outlet opening 7 by means of a pump 25. The volume flow of the sample gas exiting the outlet opening 7 is indicated by the arrow 8.

The sample gas is a gas mixture comprising different gas components, i.e. different types of gas molecules are present. The components to be analyzed can be, in particular, trace components. For example, each of the components to be analyzed can represent less than 1 vol.-%, in particular less than 1 vol.-%o of the total volume of the sample gas. For example, the sample gas is air comprising volatile organic components (VOCs).

In the reaction chamber 4 there are a first electrode 9, a second electrode 10 and a third electrode 11. The electrodes 9, 10, 11 each have the shape of a helix wound about the axis 27. The helices formed by the electrodes 9, 10, 11 end at the same locations with respect to the axis 27.

The pitches g of the helices formed by the electrodes 9, 10, 11, i.e. the distance in the direction of the axis 27 along which the respective helix winds once about the axis 27, are equal. The helices have the same inner diameters d and also the same outer diameters. The strands (=wires) forming the electrodes 9, 10, 11 and in the present case having a circular cross-section have equal diameters. Also other cross-sectional shapes are conceivable and possible.

The electrodes 9, 10, 11 form congruent helices which are offset with respect to one another by one third of the pitch p of the helices in the direction of the axis 27, wherein the helices end at the same locations with respect to the axis 27. The helices thus form a triple helix. Thus, the helices wind about one another, wherein they always have the same distance from each other along the axis 27.

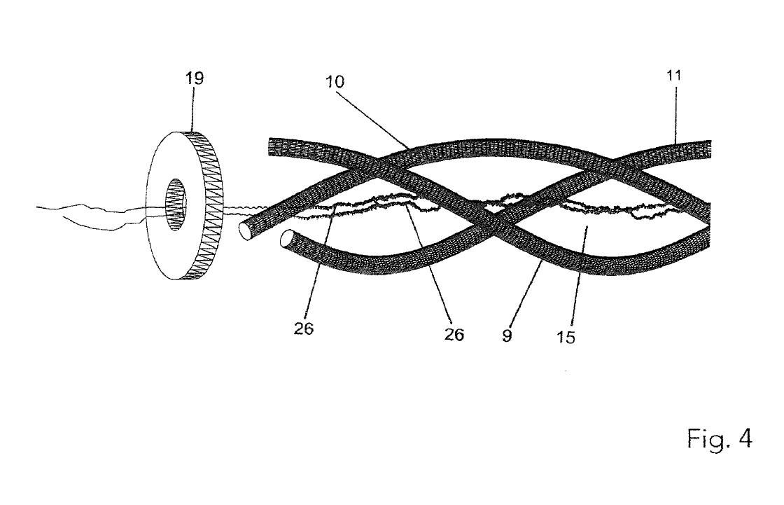

Enlarged details of sections of the helices are shown in FIG. 4.

An AC voltage source 12 has three outputs 13, each being phase-shifted by 120°. The AC voltages applied to these outputs, which are each phase-shifted by 120° and have the same signal shape, are applied to the electrodes 9, 10, 11 via connection lines 14 schematically indicated in FIG. 1.

The area which extends lengthwise in the direction of the axis 27 and about which the electrodes 9, 10, 11 wind forms a reaction space 15. The latter is thus cylindrical, with the axis 27 being the cylinder axis.

The reaction space 15 extends in the direction of the axis 27, viewed from a first end 16 through which the primary ions supplied by the ion source 1 enter the reaction space 15, up to a second end 17 through which primary ions which have passed the reaction space 15 and product ions which have been generated in the reaction space 15 by chemical ionization exit the reaction space 15 in the direction to an analyzer/detector unit 18.

By means of the AC voltage applied to the electrodes 9, 10, 11, the ions in the reaction space 15 are accelerated in the radial direction, as will be explained in more detail below. In accordance with the embodiment, the ions are transported through the reaction space 15 in the direction of the axis 27 mainly by means of the volume flow of the sample gas through the reaction space 15, as will also be explained in more detail below.

The ions exit the reaction chamber 4 through an aperture 19 limiting the reaction chamber 4 and then reach the analyzer/detector unit 18. In the shown embodiment, the analyzer/detector unit 18 directly adjoins the aperture 19. In other embodiments, an intermediate chamber might be provided through which the ions are transferred to the analyzer/detector unit.

The analyzer/detector unit determines different types of ions of the primary ions and the product ions in terms of quantity.

For accelerating the primary ions passing through the aperture 3 in the direction to the first end 16 of the reaction space 15 and for accelerating the ions exiting the second end 17 of the reaction space 15 in the direction to the aperture 19, a DC voltage source is provided, which has outputs 21 lying on different DC voltage potentials. The outputs 21 are connected to the apertures 3, 19 and the electrodes 9, 10, 11 by means of connection lines 22 schematically shown in FIG. 1. The electrodes 9, 10, 11 lie on the same DC voltage potential, which is more negative than the DC voltage potential on which the aperture 3 is lying. The DC voltage potential on which aperture 19 lies is, in case of positively charged ions, more negative than the DC voltage potential on which the electrodes 9, 10, 11 are lying.

For separating the DC voltage source 12 from the electrodes 9, 10, 11 with respect to the DC voltage potentials, the connection lines 14 comprise capacitors 23 having sufficiently large capacities for transferring the AC voltage signals of the AC voltage source 12 to the electrodes 9, 10, 11 in a largely loss-free manner.

For separating the DC voltage source 20 from the electrodes 9, 10, 11 with respect to the AC voltages, the connection lines 22 comprise choke coils 24. The latter have an inductivity that is sufficiently high for this purpose.

The analyzer/detector unit 18 comprises an analyzer for separating the ions in accordance with their masses, more exactly their mass-to-charge ratio. The analyzer/detector unit 18 further comprises a detector for detecting the previously separated ions. The analyzer/detector unit 18 thus outputs, for a respective present ion type which is characterized by a respective mass-to-charge ratio, a measuring signal having a signal strength being proportional to the number of ions per time for the respective ion type.

Different analyzers and detectors can be used, as known from conventional mass spectrometers. The analyzer is located in a chamber that is separate from the reaction chamber 4. The detector is also located in this chamber or in a further chamber that is separate from this chamber. Different configurations of analyzer/detector units 18 are known, and it is not necessary to discuss them in detail here.

If the chemical ionization of components of the sample gas is performed in the reaction space 15 by proton transfer, the following kinds of reactions take place in the reaction space 15:

XH⁺+R→RH⁺+X.

XH⁺ are the primary ions serving as the proton donators, for example H₃O⁺. R is a gas component of the sample gas that can be ionized by the primary ions by proton transfer.

When the proton transfer reactions are exothermic, the reaction rates k generally correspond to a large extent to the collision rate k_{coll}. The total number of collisions in a given primary ion flow is proportional to the pressure of the sample gas in the reaction space 15 and to the reaction time. This corresponds to the length of the reaction space 15 in the direction of the axis 27 divided by the average speed of the primary ions in the reaction space with respect to the axis 27 (=drift speed of the primary ions).

When thus formation of clusters of the primary ions is prevented, the reaction sensitivities for different gas components of the sample gas to be detected are approximately or at least to a large extent equal. Quantitative measurements can thus be carried out easily, if necessary with simple calibrations with respect to the sensitivities to different gas components to be detected.

For preventing the formation of clusters comprising primary ions in the reaction space 15, the primary ions are sufficiently highly accelerated by the AC voltage applied to the electrodes 9, 10, 11. This results in impacts of the primary ions, mainly with neutral components of the sample gas, with impact energies corresponding to their kinetic energy. Acceleration is realized mainly in the radial direction with respect to the axis 27. Except for the comparatively slight effect of the effective potential acting in the axial direction dependent on the sense of rotation of the applied AC voltages, this acceleration thus does not have any influence on the drift speed of the primary ions in the reaction space 15 in the direction of the axis 27.

In the embodiment, no DC voltage field which accelerates the ions in the direction of the axis 27 is active in the reaction space 15. In the embodiment, the ions are transported in the direction of the axis 27 from the first end 16 of the reaction space to the second end 17 of the reaction space mainly by the volume flow of the neutral sample gas through the reaction space 15, which flows everywhere in the reaction space 15 in the direction to the second end 17 of the reaction space 15, superimposed by the effective potential in the direction of the axis 27, which, depending on the sense of rotation of the phase, is active opposite to the volume flow or in the direction to the second end (17) of the reaction space. The sample gas is allowed to enter the reaction chamber 4 through the inlet opening 5 located in the area of the end of the reaction chamber 4 facing the ion source 1, and the neutral part of the sample gas is pumped out of the reaction chamber 4 through the outlet opening 7 located in the area of the end of the reaction chamber 4 facing the analyzer/detector unit 18. In the embodiment, the outlet opening 7 is an opening of the reaction chamber 4 which is separate from the aperture 19. The sample gas might also be pumped out through the aperture 19. In this case, e.g., a short intermediate chamber might adjoin the reaction chamber 4, into which the ions enter through the aperture 19 and from which the ions exit through an aperture into the analyzer/detector unit 18, wherein the neutral part of the sample gas is pumped out of the intermediate chamber through an outlet opening.

The average ion speed in the direction of the axis 27 (=drift speed) corresponds to the average speed of the neutral molecules of the sample gas in the direction of the axis 27 plus the transportation speed caused by the effective potential in the axial direction, which can be effective in the counter-direction of the average speed of the neutral molecules or in the same direction.

In accordance with different embodiments of the disclosure, the ions might rather or additionally be transported in the direction of the axis 27 from the first end 16 to the second end 17 of the reaction space 15 by means of an electrical DC field. For example, the electrodes 9, 10, 11 might consist of a material having a resistance that is sufficiently high for generating a suitable current drop along the electrodes 9, 10, 11 by a DC voltage flowing through the electrodes 9, 10, 11.

The applied DC field might also be used for reducing the speed of the ions by counter-acting the movement direction of the ions in order to thus increase the reaction time.

Depending on the application, the chemical ionization in the reaction space 15 can also take place in a manner different from proton transfer.

Advantageously, the reaction time of the primary ions in the reaction space 15 can be in the range from 10 μs to 10 ms, preferably in the range of 100 μs to 1000 μs.

The length of the reaction chamber 4 in the direction of the axis 27 can be, e.g., in the range of 5 cm to 20 cm. The reaction space 15 substantially extends along the entire length of the reaction chamber 4, at least along more than 90% of the length of the reaction chamber 4.

A relatively high pressure of the sample gas can be used in the reaction space, said pressure lying, e.g., in the range of 10 mbar to 1000 mbar, preferably in the range of 10 mbar to 100 mbar.

The volume flow of the neutral gas components of the sample gas through the reaction chamber 4 can lie, e.g., in the range of 100 sccm/min to 5000 sccm/min.

The frequency of the AC voltage applied to the electrodes 9, 10, 11 preferably lies in the range of 100 kHz to 100 MHz, wherein a range of 1 MHz to 20 MHz is particularly preferred.

The signal shape of the AC voltage applied to the electrodes 9, 10, 11 can, e.g., also be a sinusoidal voltage. Also the use of a square wave voltage is, e.g., conceivable and possible.

The amount of the AC voltage applied to the electrodes 9, 10, 11 depends in particular on the pressure of the sample gas in the reaction space 15. For example, if the pressure of the sample gas lies in the range of 10 mbar to 100 mbar, a voltage amounting to 100 Vpp to 1000 Vpp can be applied.

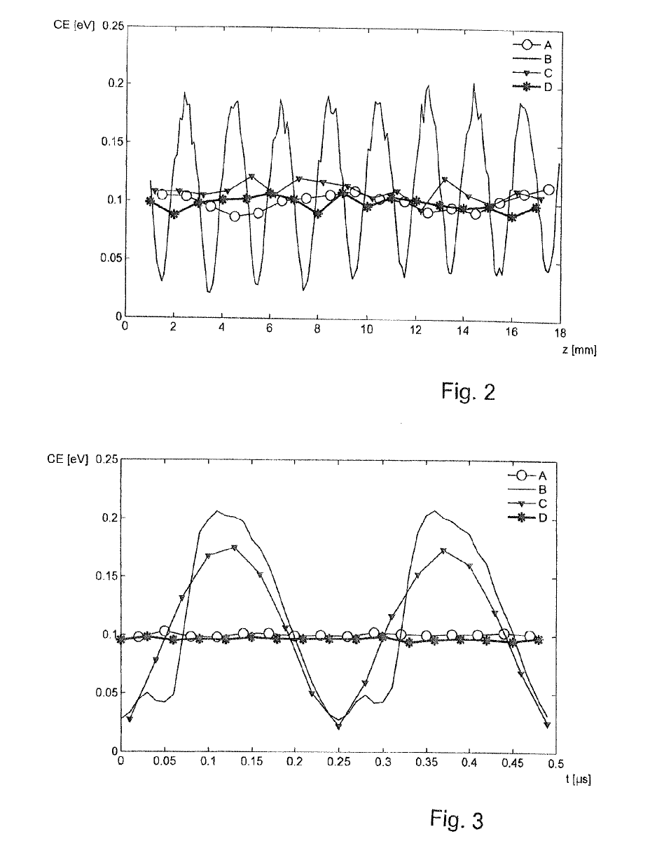

FIG. 2 shows the average impact energy CE of ion-molecule impacts depending on the axial position z in the reaction space 15, wherein curve D shows the situation for the device of the disclosure according to the embodiment of FIG. 1. It is evident that the average impact energy depends only little on the axial position z. The situation is similar to a conventional proton transfer reaction mass spectrometer as described, e.g., in the above-mentioned document of Hansel et al. The dependency in this case is shown in FIG. 2 in curve A. Curve B further shows the dependency that would be given in case successive ion lenses were used, as described in the above-mentioned document of Julian et al. The average impact energies are subject to strong fluctuations about the average value. Curve C shows the situation in case a double helix formed by two electrodes is used instead of a triple helix formed by three electrodes, wherein AC voltages being phase-shifted by 180° are applied to this double helix. Here, too, the average impact energy depends only little on the axial position z.

FIG. 3 shows the dependency of the average impact energy CE on ion-molecule impacts depending on time. The configurations on which curves A to D are based correspond to those of FIG. 2. For curves A and D, the impact energy CE is substantially constant over time, while curve B shows strong variations over time. In the time periods close to a respective zero crossing, the average impact energies are low so that undesired cluster formation might occur. The same applies to curve C relating to a configuration with a double helix. For preventing the formation of clusters when using a double helix, instead of a sinusoidal voltage a square wave voltage with very steep flanks (rise time<3 ns) would have to be used. Also the use of a sinusoidal voltage having a very high frequency in the range of more than 50 MHz, preferably more than 200 MHz, would be conceivable and possible.

FIG. 4 shows sections of the electrodes 9, 10, 11 adjoining the second end 17 of the reaction space 15, together with an aperture 19 and exemplarily shown ion trajectories 26. The speed in the direction of the axis 27 is considerably lower than the radially oscillating movement of the ions.

Preferably, the average drift speed in the direction of the axis 27 is lower than one tenth of the value of the absolute average speed in the radial direction.

Instead of a triple helix formed by three electrodes 9, 10, 11, the reaction space 15 might also be surrounded by a multiple helix formed by more than three electrodes. The AC voltage source 12 would then output a corresponding number of AC voltages having the same signal shape and the same frequency and being phase-shifted in pairs by respective equal amounts, and said AC voltages would then be applied to the electrodes. For example, in case four electrodes are used, the phase shift between the second and the first AC voltage, the third and the second AC voltage, the fourth and the third AC voltage as well as the first and the fourth AC voltage would be 90° each.

Starting from a number of three electrodes forming helices winding about one another, an electrical field having an absolute value constant in time would thus be achieved. The direction of the electrical field rotates continuously within a phase (with respect to a specific location along the axis 27).

In case of a double helix configuration, AC voltages being phase-shifted by 180° are applied to the two electrodes. With respect to a specific location along the axis, the value of the electrical field oscillates as a function of the phase and the electrical field does not rotate.

In accordance with the embodiment, the helices formed by electrodes 9, 10, 11 have the same diameter (inner and outer diameters) along their entire extension in the direction of the axis 27. Preferably, this is the case along at least 80%, particularly preferably 90% of the extension of the helices in the direction of the axis 27. For example, in the area adjoining the first end 16 of the reaction space 15, the helices can also have a diameter (inner and outer diameters) reducing in the direction to the second end 17 of the reaction space 15. This might lead to a certain focusing of the primary ions entering the reaction space 15 through the aperture 3. Additionally or instead, the diameter (inner and outer diameters) of the helices might possibly be reduced in an area adjoining the second end 17 in the direction to the second end 17. This might lead to a certain focusing of the ions in the direction to the opening of the second aperture 19.

### LEGEND OF REFERENCE NUMBERS

1 ion source
2 arrow
3 aperture
4 reaction chamber
5 inlet opening
6 arrow
7 outlet opening
8 arrow
9 first electrode
10 second electrode
11 third electrode
12 AC voltage source
13 output
14 connection line
15 reaction space
16 first end
17 second end
18 analyzer/detector unit
19 aperture
20 DC voltage source
21 output
22 connection line
23 capacitor
24 choke coil
25 pump
26 ion trajectory
27 axis

What is claimed is:

1. A device for analyzing a sample gas comprising
an ion source for generating primary ions,
a reaction chamber to which the primary ions generated in the ion source and the sample gas to be analyzed can be supplied for generating product ions by chemical ionization of components of the sample gas,
and
an analyzer/detector unit for determining different types of ions,
characterized in that a reaction space of the reaction chamber in which the primary ions supplied to the reaction space and the generated product ions are guided and which extends between a first end facing the ion source and a second end facing the analyzer/detector unit is surrounded by at least two electrodes which are formed as helices winding together about a common axis and having equal pitches (g) and being offset with respect to one another in the direction of the axis and to each of which an AC voltage is applied.

2. The device according to claim 1, wherein for transporting the primary ions and the generated product ions in the direction to the second end of the reaction space, the sample gas flows through the reaction space in a manner directed towards the second end of the reaction space.

3. The device according to claim 1, wherein the helices formed by the electrodes are congruent, wherein the electrodes each end at the same locations with respect to the direction of the axis.

4. The device according to claim 1, wherein that the inner diameters (d) of the helices formed by the electrodes are constant along at least 80% of the extension of the reaction space with respect to the axis.

5. The device according to claim 4, wherein the inner diameters (d) of the helices formed by the electrodes are constant along the entire extension of the reaction space with respect to the axis.

6. The device according to claim 1, characterized wherein the reaction space is surrounded by at least three electrodes which are formed as helices winding about a common axis and having equal pitches (g) and being offset with respect to one another in the direction of the axis and to each of which the AC voltage is applied.

7. The device according to claim 1, characterized wherein the AC voltages applied to the electrodes are phase-shifted.

8. The device according to claim 1, wherein the reaction space is surrounded by at least three electrodes which are formed as helices winding about the common axis and having equal pitches (g) and being offset with respect to one another in the direction of the axis and to each of which the AC voltage is applied.

9. The device according to claim 8, wherein the reaction space is surrounded by a triple helix formed by the electrodes, wherein the AC voltages applied to the electrodes are each phase-shifted by 120°.

10. The device according to claim 1, wherein each of the offsets along the axis between successive helices has the same size and each of the phase offsets between the AC voltages applied to the electrodes forming successive helices has the same size.

11. The device according to claim 8, wherein for transporting the primary ions and the generated product ions in the direction to the second end of the reaction space, the sense of rotation of the phase of the applied AC voltages is selected such that an effective potential is generated along the axis, which leads to a transporting speed of the primary ions and the generated product ions in the direction to the second end of the reaction space.

12. The device according to claim 1, wherein the frequency of the AC voltages applied to the electrodes lies in the range of between about 1 MHz to about 20 MHz.
